(19) United States
(12) Patent Application Publication
(10) Pub. No.: US 2010/0000653 A1
(43) Pub. Date: Jan. 7, 2010

(54) HEAT-ACTIVABLE ADHESIVE TAPE PARTICULARLY FOR BONDING ELECTRONIC COMPONENTS AND CONDUCTOR TRACKS

(75) Inventors: Thorsten Krawinkel, Hamburg (DE); Christian Ring, Hamburg (DE); Sevil Ece, Hamburg (DE)

Correspondence Address: GERSTENZANG, WILLIAM C., 875 THIRD AVE, 8TH FLOOR, NEW YORK, NY, 10022, US

(73) Assignee: TESA AG, Hamburg (DE)

(21) Appl. No.: 12/440,408

(22) PCT Filed: Sep. 24, 2007
(86) PCT No.: PCT/EP2007/060121

§ 371 Date: May 13, 2009

(30) Foreign Application Priority Data
Oct. 6, 2006 (DE) 10 2006 047 739.1

(51) Int. Cl. B32B 37/02; C08L 77/00; C08K 5/12; C08K 3/32

(52) U.S. Cl. 156/60; 524/538; 524/296; 524/417; 524/270

(57) ABSTRACT

Heat-activable adhesive tape particularly for producing and further processing electronic components and conductor tracks, with an adhesive composed at least of a) a polyamide having terminal amino and/or acid groups, b) an epoxy resin, c) if desired, a plasticizer, the polyamide reacting with the epoxy resin at temperatures of at least 150° C., and the ratio in weight fractions of a) to b) lying between 50:50 to 99:1.

The invention relates to a heat-activable adhesive of low fluidity at high temperatures particularly for bonding flexible printed conductor tracks (flexible printed circuit boards, FPCBs).

Flexible printed circuit boards are nowadays employed in a multiplicity of electronic devices such as mobile phones, radios, computers, printers and many more. They are constructed from layers of copper and a high-melting resistant thermoplastic: mostly polyimide, less often polyester. These FPCBs are frequently produced using adhesive tapes with particularly exacting requirements. On the one hand, for producing the FPCBs, the copper foils are bonded to the polyimide sheets; on the other hand, individual FPCBs are also bonded to one another, in which case polyimide bonds to polyimide. In addition to these applications, the FPCBs are also bonded to other substrates.

The adhesive tapes used for these bonding tasks are subject to very exacting requirements. Since very high bond performances must be attained, the adhesive tapes used are generally heat-activable tapes, which are processed at high temperatures. These adhesive tapes must not emit volatile constituents in the course of this high temperature load during the bonding of the FPCBs, which often takes place at temperatures around 200° C. In order to achieve a high level of cohesion the adhesive tapes ought to crosslink during this temperature load. High pressures during the bonding operation make it necessary for the flowability of the adhesive tapes at high temperatures to be low. This is achieved by high viscosity in the uncrosslinked adhesive tape or by very rapid crosslinking. Moreover, the adhesive tapes must also be solder bath resistant, in other words must for a short time withstand a temperature load of 288° C.

For this reason the use of pure thermoplastics is not rational, despite the fact that they melt very readily, ensure effective wetting of the bond substrates and lead to very rapid bonding within a few seconds. At high temperatures, though, they are so soft that they tend to swell out of the bondline under pressure in the course of bonding. Accordingly there is no solder bath resistance either.

For crosslinkable adhesive tapes it is usual to use epoxy resins or phenolic resins, which react with specific hardeners to form polymeric networks. In this specific case the phenolic resins cannot be used, since in the course of crosslinking they generate elimination products, which are released and, in the course of curing or, at the latest, in the solder bath, lead to blistering.

Epoxy resins are employed primarily in structural adhesive bonding and, after curing with appropriate crosslinkers, produce very brittle adhesives, which indeed achieve high bond strengths but possess virtually no flexibility.

Increasing the flexibility is vital for use in FPCBs. On the one hand the bond is to be made using an adhesive tape which ideally is wound onto a roll; on the other hand the conductor tracks in question are flexible, and must also be bent, readily apparent from the example of the conductor tracks in a laptop, where the foldable screen is connected via FPCBs to the further circuits.

Flexibilizing these epoxy resin adhesives is possible in two ways. First, there exist epoxy resins flexibilized with elastomer chains, but the flexibilization they experience is limited, owing to the very short elastomer chains. The other possibility is to achieve flexibilization through the addition of elastomers, which are added to the adhesive. This version has the drawback that the elastomers are not crosslinked chemically, meaning that the only elastomers that can be used are those which at high temperatures still retain a high viscosity.

Because the adhesive tapes are produced generally from solution it is frequently difficult to find elastomers of a sufficiently long-chain nature not to flow at high temperatures while being still of a sufficiently short-chain nature that they can be brought into solution.

Production via a hotmelt operation is possible but very difficult in the case of crosslinking systems, since it is necessary to prevent premature crosslinking during the production operation.

Compositions of particular cohesion and high bond strength can be obtained through the use of a soluble polyamide which is crosslinked with epoxy resins. A drawback is that these adhesives have a very high softening point.

The high softening point of the polyamides means that processing is possible only at high temperatures. Moreover, the stability on storage of adhesives composed of polyamide, epoxy resin and hardeners is limited.

Crosslinkable adhesives based on polyamide or derivatives thereof have been described.

The polyamides in question, as in U.S. Pat. No. 5,885,723 A or JP 10 183 074 A or JP 10 183 073 A, are modified polyamides which preferably contain polycarbonate groups or polyalkylene glycol groups. These polyamides are reacted so that they contain epoxide end groups and, as a result, can be crosslinked with the epoxides by means of a hardener.

Otherwise disclosed are adhesives with polyamideimides of very specific composition, in U.S. Pat. No. 6,121,553 A, for example.

WO 00/01782 A1 describes adhesives also based on polyamides and crosslinking resins. In these adhesives, however, the epoxy resins react with a hardener and so form a three-dimensional network, the polyamide serving only as a flexibilizer.

It is an object of the invention, therefore, to provide an adhesive tape which is heat-activable, crosslinks in the heat, possesses a low viscosity in the heat, displays effective adhesion to polyimide and in the uncrosslinked state is soluble in organic solvents.

This object is achieved, surprisingly, by means of an adhesive tape as characterized in more detail in the main claim. The dependent claims provide advantageous developments of the subject-matter of the invention and also possibilities for its use.

A heat-activable adhesive particularly for producing and further processing electronic components and conductor tracks, with an adhesive composed at least of

a) a polyamide having terminal amino and/or acid groups,
b) an epoxy resin,
c) if desired, a plasticizer,
the polyamide reacting with the epoxy resin at temperatures of at least 150° C., and the ratio in weight fractions of a) to b) lying between 50:50 to 99:1.

The general expression “adhesive tape” for the purposes of this invention embraces all sheetlike structures, such as two-dimensionally extended sheets or sheet sections, tapes with extended length and limited width, tape sections, diecuts and the like.

The ratio in weight fractions of a) to b) lies preferably between 70:30 to 95:5.

The polyamides used in the adhesives of the invention ought to have not too high a molecular weight (preferably a weight-average molecular weight M_{w} of less than 40 000) and ought to have been flexibilized and/or only partly crystalline or not crystalline at all. This is necessary on the one hand for the described flexibility of the adhesives; on the other hand, the raw materials are processed preferably from solution, and completely crystalline polyamides are difficult to dissolve, and can be dissolved only in inconvenient solvents such as trifluoroacetic acid or sulphuric acid.

Consequently, according to one advantageous development of the invention, copolymers are used instead of the homopolymers such as PA 6,6. To flexibilize the PA 6,6 it can be copolymerized with PA 6. Other copolymers, such as PA 6,6/6,12 or PA 6,6/6,11, for example, can likewise be employed. Reducing the molecular weight raises the solubility of the polyamides. The molecular weight ought not to be lower to a point where the good mechanical properties are lost.

The weight-average molecular weight M_{w} ought to be greater than 500 g/mol.

In order to lower the crystallinity further it is also possible to use terpolymers. Not only purely aliphatic polyamides can be employed, but also aliphatic-aromatic polyamides. Preference is given to those which have a long aliphatic chain or ideally, as a result of copolymerization, have aliphatic chains which differ in length. An improvement in solubility here can also be accomplished by the use of aromatics having meta and/or ortho substitution. The use of isophthalic acid in place of terephthalic acid lowers the crystallinity considerably. In order to lower the crystallinity in aliphatic-aromatic polyamides it is also possible to employ monomers of the following formula:

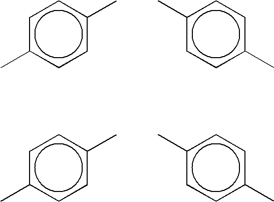

In these formulae X can be oxygen, nitrogen or sulphur, but may also be an alkylene group having at least one carbon atom. An isopropylene group is also possible.

Likewise possible are extensions to these structures through substituents in the aromatics, or a prolongation of the structure by means of further aromatic groups.

Further examples of amines which can be used in accordance with the invention are given in U.S. Pat. No. 6,121,553 A.

Polyesteramides as well can be used, subject to the proviso that they are soluble in a solvent that is suitable for application to a backing.

For the synthesis of the polyamide it is important that either the amino component(s) or the acid component(s) are used in excess, so that on the one hand the molecular weight does not become too high and on the other hand that terminal reactive groups are present which can react with the epoxy resins.

Since the polyamides are crosslinked, it is also possible to use fairly low molecular weight oligomers (specifically those having a weight-average molecular weight M_{w} of 500 to 2000 g/mol), in order to obtain sufficient strength.

Epoxy resins are usually understood to be not only monomeric but also oligomeric compounds containing more than one epoxide group per molecule. They may be reaction products of glycidyl esters or epichlorohydrin with bisphenol A or bisphenol F or mixtures of these two. Likewise suitable for use are epoxy novolak resins, obtained by reacting epichlorohydrin with the reaction product of phenols and formaldehyde. Monomeric compounds containing two or more epoxide end groups, used as diluents for epoxy resins, can also be employed. Likewise suitable for use are elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079, likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized elastomers are available from Noveon under the name Hycar.

Epoxy diluents, monomeric compounds containing two or more epoxide groups, are for example Bakelite™ EPD KR, EPD Z8, EPD HD, EPD WF, etc. from Bakelite AG or Polypox™ R 9, R 12, R 15, R 19, R 20 etc. from UCCP.

In one preferred embodiment of the invention more than one epoxy resin is used simultaneously.

The high strength of the polyamides and the additional crosslinking of the epoxy resin means that very high strengths are achieved within the adhesive film. The bond strengths to the polyimide as well, however, are extremely high.

Ideally the epoxy resins and the polyamides are employed in a proportion such that the molar fraction of epoxide groups and amino groups and/or acid groups is just equivalent. However, the proportion between hardener groups and epoxide groups can be varied within wide ranges, although for sufficient crosslinking neither of the two groups ought to be present in a molar equivalent excess of more than ten times.

For additional crosslinking it is also possible to add chemical crosslinkers which react with the epoxy resins. Crosslinkers are not necessary for the reaction but can be added particularly for the purpose of scavenging excess epoxy resin.

As crosslinkers or hardeners the compounds primarily employed are as follows and as described in more detail in U.S. Pat. No. 3,970,608 A:
polyfunctional aliphatic amines, such as triethylenetetramine for example
polyfunctional aromatic amines, such as isophoronediamine for example
guanidines, such as dicyandiamide for example
polyhydric phenols
polyhydric alcohols
polyfunctional mercaptans
polybasic carboxylic acids
acid anhydrides with one or more anhydride groups

Although adhesive tapes based on polyamide and epoxy resin, with and without hardener, can achieve very high holding powers, the softening point of these adhesives is comparatively high, which in certain cases restricts processing. Because the adhesive tapes are laminated prior to pressing to the article that is to be bonded, a very high temperature of above 160° C. is needed. In order to lower this temperature, plasticizers are added to the adhesives in one further preferred embodiment of the invention. Tests also show that the stability after storage is much higher for plasticizers-blended polyamide-based adhesives than for those without added plasticizers. Besides the laminating temperature, it is also possible for the addition of plasticizers to lower the crosslinking temperature, and at the same time the storage stability is increased.

Suitable plasticizers first include the plasticizers typically employed in PVC.

These may be selected, for example, from the groups of the
phthalates such as DEHP (diethylhexyl phthalate), DBP (dibutyl phthalate), BBzP (butyl benzyl phthalate), DnOP (di-n-octyl phthalate), DiNP (diisononyl phthalate) and DiDP (diisodecyl phthalate)
trimellitates such as TOTM (trioctyl trimellitate), TINTM (triisononyl trimellitate)
aliphatic dicarboxylic esters such as DOM (dioctyl maleate), DOA (dioctyl adipate) and DINA (diisononyl adipate)
phosphoric esters such as TCEP (tris(2-chloroethyl)phosphate)
natural oils such as castor oil or camphor

In addition it is also possible to use the following plasticizers:
low molecular weight polyalkylene oxides, such as polyethylene oxides, polypropylene oxides and polyTHF
rosin-based tackifier resins with a low softening point, such as Abalyn or Foralyn 5040 from Eastman

Preference is given here to the last two groups, on account of their better environmental compatibility and the reduced tendency to diffuse out of the adhesive assembly. Mixtures of the individual plasticizers can be employed as well.

In order to raise the reaction rate of the crosslinking reaction it is possible to use what are known as accelerators.

Examples of possible accelerators include the following:
tertiary amines, such as benzyldimethylamine, dimethylaminomethylphenol and tris(dimethylaminomethyl)phenol
boron trihalide-amine complexes
substituted imidazoles
triphenylphosphine

Further additives which can be used typically include:
primary antioxidants, such as sterically hindered phenols
secondary antioxidants, such as phosphites or thioethers
in-process stabilizers, such as C-radical scavengers
light stabilizers, such as UV absorbers or sterically hindered amines
processing assistants
fillers, such as silicon dioxide, glass (ground or in the form of beads), aluminium oxides, zinc oxides, calcium carbonates, titanium dioxides, carbon blacks, metal powders, etc.
colour pigments and dyes and also optical brighteners

To produce the adhesive tape the constituents of the adhesive are dissolved in a suitable solvent, for example hot ethanol, hot methanol, N-methylpyrrolidone, dimethylformamide, dimethylacetamide, dimethyl sulphoxide, γ-butyrolactone or halogenated hydrocarbons or mixtures of these solvents, and the solution is coated onto a flexible substrate provided with a release layer, such as a release paper or release film, for example, and the coating is dried, so that the composition can be easily removed again from the substrate. Following appropriate converting, diecuts, rolls or other shapes can be produced at room temperature. Corresponding shapes are then adhered, preferably at elevated temperature, to the substrate to be bonded, polyimide for example.

It is also possible to coat the adhesive directly onto a polyimide backing. Adhesive sheets of this kind can then be used for masking copper conductor tracks for FPCBs.

It is not necessary for the bonding operation to be a one-stage process; instead, the adhesive tape can first be adhered to one of the two substrates by carrying out hot lamination. In the course of the actual hot bonding operation with the second substrate (second polyimide sheet or copper foil), the epoxide groups then fully or partly cure and the bondline attains the high bond strength.

The admixed epoxy resins and the polyamides should preferably not yet enter into any chemical reaction at the lamination temperature, but instead should react with one another only on hot bonding.

As compared with many conventional adhesives for the bonding of FPCBs, the adhesives produced have the advantage of possessing, after bonding, a very high temperature stability, so that the assembly created remains of high strength even at temperatures of more than 150° C.

An advantage of the adhesives of the invention is that the elastomer is in fact chemically crosslinked with the resin; there is no need to add a hardener for the epoxy resin, since the elastomer itself acts as hardener.

This crosslinking may take place both via terminal acid groups and via terminal amino groups. Crosslinking via both mechanisms simultaneously is also possible. In order that enough end groups are present, the molecular weight of the polyamides must not be too high, since otherwise the degree of crosslinking becomes too low. Molecular weights above 40 000 lead to products with only a little crosslinking.

The determinations of the weight-average molecular weights M_{w} were carried out by means of gel permeation chromatography (GPC). The eluent used was THF (tetrahydrofuran) containing 0.1% by volume trifluoroacetic acid. Measurement was made at 25° C. The preliminary column used was PSS-SDV, 5μ, 10³ Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml per minute. Measurement was carried out against PMMA standards.

### EXAMPLES

The invention is described in more detail below by a number of examples, without restricting the invention in any way whatsoever.

### Example 1

90 parts of a copolyamide 6/66/136 having a viscosity number in 96% strength sulphuric acid to ISO 307 of 122 ml/g (Ultramid 1C from BASF) are dissolved with stirring in boiling ethanol (20% strength solution), and the cooled solution is admixed with 10 parts of the epoxy resin EPR 161 (Bakelite, epoxide number of 172).

After the components have fully dissolved, the solution is coated out onto a siliconized backing, so that drying gives an adhesive film of 25 μm.

### Comparative Example 2

90 parts of the above-described copolyamide in which the terminal amino groups are reacted with benzoyl chloride are dissolved as described above in ethanol and admixed with EPR 161 (10 parts).

### Comparative Example 3

Preparation of an adhesive in the same way as in Example 1, with the proportions of polyamide to epoxy resin of 40:60.

### Example 4

90 parts of a copolyamide 6/66/136 having a viscosity number in 96% strength sulphuric acid to ISO 307 of 122 ml/g (Ultramid 1C from BASF) are dissolved with stirring in boiling ethanol (20% strength solution), and the cooled solution is admixed with 10 parts of the epoxy resin EPR 166 (Bakelite, epoxide number of 184), 20 parts of a polyethylene glycol having an average molar mass of 2000, and the tackifier resin Foralyn 5040 from Eastman.

After the components have fully dissolved, the solution is coated out onto a siliconized backing, so that drying gives an adhesive film of 25 μm.

### Comparative Example 5

The polyamide is dissolved as in Example 4, but this time the two plasticizers are omitted. Once again, an adhesive film with a thickness of 25 μm is coated out as described above.

### Example 6

The ingredients are as in Example 4, with the further addition of 2 parts of dicyandiamide as a hardener for the epoxy resin.

### Comparative Example 7

90 parts of the above-described copolyamide in which the terminal amino groups are reacted with benzoyl chloride are dissolved as described above in ethanol and admixed with EPR 161 (10 parts) and the two plasticizers from Example 4.

Bonding of FPCBs with the Adhesive Tape Produced

Two FPCBs are bonded using in each case one of the adhesive tapes produced in accordance with Examples 1 to 3. For this purpose the adhesive tape is laminated onto the polyimide sheet of the polyimide/copper foil FPCB laminate at 170° C. Subsequently a second polyimide sheet of a further FPCB is bonded to the adhesive tape and the whole assembly is compressed in a heatable Bürkle press at 200° C. and a pressure of 1.3 MPa for one hour.

Two FPCBs are each bonded with the adhesive tapes produced according to Examples 4 to 7. This is done by laminating the adhesive tape onto the polyimide sheet of the polyimide/copper foil FPCB laminate at 140° C. and 170° C. Subsequently a second polyimide sheet of a further FPCB is adhered to the adhesive tape, and the whole assembly is compressed in a heatable Bürkle at 200° C. and a pressure of 1.3 MPa for one hour.

### Test Methods

The properties of the adhesive sheets produced in accordance with the examples specified above is investigated by the following test methods.

### Laminating Temperature

A measurement is made of the minimum temperature at which the adhesive tape can be laminated onto a polyimide backing without automatically detaching.

T-Peel Test with FPCB

Using a tensile testing machine from Zwick, the FPCB/adhesive tape/FPCB assemblies produced in accordance with the process described above are peeled from one another at an angle of 180° and with a rate of 50 mm/min, and the force required, in N/cm, is measured. The measurements are made at 20° C. and 50% relative humidity. Each measurement value is determined three times.

### Temperature Stability

In analogy to the T-peel test described, the FPCB assemblies produced in accordance with the process described above are suspended so that one of the two resulting grip tabs is fixed at the top, while a weight of 500 g is fixed to the other grip tab, so forming an angle of 180° between the two FPCBs. A measurement is then made of the temperature at which, after 30 minutes, it is possible to measure a peel travel of more than 10 mm.

### Solder Bath Resistance

The FPCB assemblies bonded in accordance with the process described above are laid for 10 seconds onto a solder bath which is at a temperature of 288° C. The bond is rated solder bath resistant if there is no formation of air bubbles which cause the polyimide sheet of the FPCB to inflate. The test is rated as failed if there is even slight formation of bubbles.

### Results:

For adhesive assessment of the abovementioned examples the T-peel test is conducted first of all.

The results are given in Table 1.

TABLE 1
T-peel test [N/cm]

| | |
|---|---|
| Example 1 | Delamination of the copper/polyimide assembly at about |
| | 15 N/cm. No failure of the bond with inventive adhesive |
| | tape |
| Comparative | 1.8 |
| Example 2 | |
| Comparative | Very brittle, no flexible bonding possible |
| Example 3 | |
| Example 4 | Delamination of the copper/polyimide assembly at about |
| | 15 N/cm. No failure of the bond with inventive adhesive |
| | tape |
| Comparative | Delamination of the copper/polyimide assembly at about |
| Example 5 | 15 N/cm. No failure of the bond with inventive adhesive |
| | tape |
| Example 6 | Delamination of the copper/polyimide assembly at about |
| | 15 N/cm. No failure of the bond with inventive adhesive |
| | tape |
| Comparative | 1.8 |
| Example 7 | |

As can be seen, a flexible adhesive was produced in Example 1, which is excellently suited to the application and exhibits very high bond strengths.

If the polyamide is unable to react with the epoxy resins, the resulting bond strength values are much lower than when reaction has taken place.

As a result of an excessively high epoxy resin content, the adhesives are too brittle for application.

In Examples 4 and 6 as well it was possible to produce flexible adhesives which are excellently suited to the application and exhibit very high bond strengths.

Comparative Example 5 as well exhibits good bond strengths, but is only limited in processing as a result of the very high laminating temperature.

If the polyamide is unable to react with the epoxy resins, as in Comparative Example 7, the resulting bond strength values are significantly lower than when reaction has taken place.

The temperature stability of the adhesive tapes is measured using the static peel test, whose values can be found in Table 2.

TABLE 2
Static T-peel test [failure temperature in ° C.]

| | |
|---|---|
| Example 1 | At 180° C., delamination of the copper/imide assembly, |
| | still no failure of the inventive adhesive |
| Comparative | Failure at 65° C. |
| Example 2 | |
| Comparative | Very brittle, no flexible bonding possible |
| Example 3 | |
| Example 4 | 160° C. |
| Comparative | At 180° C., delamination of the copper/imide assembly, |
| Example 5 | still no failure of the inventive adhesive |
| Example 6 | 170° C. |
| Comparative | 65° C. |
| Example 7 | |

As can be seen, the temperature stability in the case of reference specimen 2 is much lower than in the case of Example 1. It is apparent that the temperature stability of the crosslinked specimen is better than in the case of the non-crosslinking specimen.

In spite of the addition of the plasticizers, the bond strength even at high temperatures is almost just as high as in the case of Comparative Example 5.

As a result of the addition of plasticizers it is also possible to lower the reaction temperature; on pressing at 180° C. instead of 200° C. as described above, the bond strengths in the case of Examples 4 and 6 are similarly high, whereas Comparative Example 5 undergoes incomplete crosslinking, with the consequence of a marked fall in bond strengths.

The same tests as described above were repeated after the unbonded samples had been stored at room temperature, after 6 months with Examples 4 to 6. Whereas specimens 4 and 6 showed very similar values and still had very high bond strengths, Comparative Example 5 had become much weaker—the bond strength in the T-peel test was now 2 N/cm.

The solder bath test was passed by Examples 1 and 2 and also by Examples 4 to 6.

In the course of determining the laminating temperature it was found that Examples 4, 6 and 7 with plasticizer could be laminated at 120° C., whereas in the case of Example 5 this was only possible at 170° C.

1. Heat-activable adhesive tape, with an adhesive composed at least of
a) a polyamide having terminal amino and/or acid groups,
b) an epoxy resin,
c) optionally, a plasticizer,
wherein the polyamide reacts with the epoxy resin at temperatures of at least 150° C., and the weight ratio in of a) to b) is between 50:50 to 99:1.

2. Heat-activable adhesive tape according to claim 1, wherein the polyamide is a non-crystalline copolyamide.

3. Heat-activable adhesive tape according to claim 1 wherein the viscosity number of the polyamide in 96% strength sulphuric acid, measured in accordance with ISO 307, is 100 to 130 ml/g.

4. Heat-activable adhesive tape according to claim 1, wherein the plasticizer is selected from the group consisting of phthalates, trimellitates, phosphoric esters, natural oils, polyalkylene oxides, rosins, polyethylene glycol and combinations thereof.

5. Heat-activable adhesive tape according to claim 1, wherein the function of the plasticizer is between 5% by weight and 45% by weight of the total mass of the adhesive.

6. Heat-activable adhesive tape according to claim 1, wherein the adhesive tape comprises accelerators, dyes, carbon black, metal powders or combinations thereof.

7. A method for bonding plastic parts which comprises bonding said parts with the heat-activable adhesive tape of claim 1.

8. Method for bonding electronic components or flexible printed circuits (FPCBs) which comprises bonding said electronic components or flexible printed circuits with the heat-activable adhesive tape of claim 1.

9. Method for bonding an object to polyimide which comprises bonding said object to polyimide with the heat-activable adhesive tape of claim 1.

10. The heat-activable adhesive tape of claim 2, wherein said non-crystalline copolyamide is PA 6,6/6,12 or PA 6,6/6,11.
